(19) United States
(12) Patent Application Publication
(10) Pub. No.: US 2017/0140411 A1
(43) Pub. Date: May 18, 2017

(54) SYSTEMS AND METHODS FOR PROVIDING LOYALTY AWARDS OF STOCK

(71) Applicant: Stockpile, Inc., Palo Alto, CA (US)

(72) Inventors: Avinash S. Lele, Palo Alto, CA (US); Sanjeev R. Kulkarni, Princeton, NJ (US)

(21) Appl. No.: 15/383,745

(22) Filed: Dec. 19, 2016

Related U.S. Application Data
(63) Continuation-in-part of application No. 14/724,377, filed on May 28, 2015.
Application No. 14/724,377 is a continuation of application No. 13/022,309, filed on Feb. 7, 2011, now abandoned.
Application No. 13/022,309 is a continuation of application No. 13/083,258, filed on Apr. 8, 2011, now abandoned.

(51) Int. Cl. G06Q 30/02

(52) U.S. Cl. CPC G06Q 30/0216; G06Q 30/0226

(57) ABSTRACT

A system and method of providing promotional rewards of stock in a company to customers who engage in a promotional activity, wherein the promotional reward is a fractional share of stock that is transferred to the customer.

This application is a continuation-in-part of U.S. patent application Ser. No. 14/724,377 titled Systems and Methods for Providing Gift Certificates of Stock, filed on May 28, 2015, which is a continuation of U.S. patent application Ser. No. 13/022,309 titled Systems and Methods for Providing Gift Certificates of Stock filed Feb. 7, 2011, now abandoned, and a continuation of U.S. patent application Ser. No. 13/083,258 titled Systems and Methods for Providing Loyalty Awards of Stock, filed Apr. 8, 2011, the disclosures of which are hereby incorporated by reference.

### BACKGROUND

The present disclosure is directed to systems and methods for providing loyalty awards of stock.

Probably as old as the concept of retailing is the question of how to grow sales and generate loyalty. Retailers and other sellers have long offered discounts, rebates, and other incentives to attract business. For example, cash discounts for specific items or an entire purchase have been widely used to attract customers and increase sales. So, too, have mail-in rebates, where a consumer sends in a UPC code from the product packaging, a sales receipt, or other proof of purchase to a rebate processing center and receives a check in the mail several weeks later. Cash incentives also have been employed by the credit card industry. Discover Card, for example, offers a credit card that gives the cardholder a percentage cash rebate on purchases made with the card. For some cards, the percentage of the rebate may vary depending on what is being purchased (e.g., affinity cards that provide a higher percentage for gasoline fill-ups, hotel stays, etc.).

Despite their ubiquity, cash incentives have drawbacks. Although they can get a customer to make a purchase, cash incentives do not necessarily generate loyalty that endures after the purchase. This is because there is nothing to remember them by after they are received. Once people leave the grocery store, they usually do not think about the $1.57 they saved at the cash register because the box of laundry detergent was on sale. Instead, the cash savings or rebate ends up being commingled with other cash in the customer's pocketbook.

Accordingly, many companies have looked to non-cash incentives and rewards. The airline industry, for example, pioneered the concept of “frequent flyer” programs, where travelers earn airline miles redeemable for future travel based on how much and how often they fly. Because the miles typically are not transferable from one airline to another, and because the most coveted travel awards and benefits are reached at higher mileage levels, many travelers become loyal to a small number of airlines. But airline mileage programs suffer from problems as well. Many travelers find it hard to redeem their miles for a free trip or an upgrade due to limited availability, blackout periods, add-on fees, and other restrictions. This has led to a problem for the airlines as well—an increasing amount of liability for outstanding miles that must be carried on the company's balance sheet year after year.

Some of these problems have been exacerbated by the fact that airline miles have become a common loyalty currency that is frequently awarded by companies other than the airlines themselves. Car rental companies like Avis, for example, purchase miles from United Airlines and award them to customers who rent cars from Avis. This has made it even harder to redeem miles for free trips or upgrades, because demand exceeds supply by an even greater margin. As a result, the airlines' liability for outstanding miles has increased even more dramatically.

There are problems from the awarding merchant's perspective as well. For example, when Avis gives out United miles, the bond that forms is between the customer and United, not the customer and Avis. As the United miles accumulate in the Avis customer's account, the customer is thinking of United and the free trip to Hawaii she has planned, not Avis or an Avis rental car. Even worse, the significant amount that Avis spends on miles does not generate much, if any, loyalty at all. This is because a customer who earns, say, 500 United miles by renting a car at Avis today can earn the exact same 500 United miles next week by renting a car at Hertz—Avis's direct competitor—because both companies are awarding the common currency of someone else.

Rewards points are another form of non-cash incentives that are widely used. Many companies have rewards programs in which customers can earn points as they make purchases. The points may be redeemed for a variety of items, typically products, services, and gift cards of other merchants. Rewards programs with a number of these redemption options make it easier for customers to redeem their points, so long as the redemption options include something the customer wants. Otherwise, the customer ends up having to pick the best of the available options or allow his points to expire. In addition, just as with airline miles, when points earned at one merchant are redeemable for goods or services at another merchant, the award serves to remind the customer of the other merchant, not the merchant who funded and gave the award.

An alternative to miles and points as the rewards currency is financial services rewards. In this case, a customer may earn credits for purchases made at participating merchants, and the credits may be applied toward the purchase of financial instruments, such as a mutual fund. But a mutual fund typically includes the stocks of many companies, and this can broadly disperse or even eliminate any loyalty generated through the program. For example, when a customer shops at Company A, she may end up with the stock of Company A as well as a host of other companies that are in the mutual fund. Much of the money that A spends on the program thus could end up funding the development of relationships between the customer and other companies. See, e.g., Upromise, at www.upromise.com, where a customer can make eligible purchases from participating merchants and accumulate the earnings in a Upromise account until she decides to invest in a 529 plan, pay down eligible student loans, or assist with college expenses.

Worse, an attempt to generate loyalty through such a program could backfire if the mutual fund includes stock in a competitor of A. Consider an example in which the fund includes more shares of stock in the competitor than in Company A. In this case, as participating customers make purchases at A, they could end up owning more and more stock in the competitor than they do in A. See, e.g., U.S. Pat. No. 6,345,261, which describes a customer loyalty investment program in which rebates are received from participating merchants as customers make purchases, and then may be invested in an investment fund. The fund comprises the merchants' stocks, and fund investments are made periodically in proportion to the total rebate received from each merchant during the period. Customers receive shares of the mutual fund in proportion to the total of the rebates attributable to their purchases during the period.

Other issues can arise where the rebates are applied toward the purchase of a share of the merchant's stock rather than shares in a mutual fund. For example, a high share price can be problematic, especially if it is too high relative to the size of a typical customer purchase. Consider a situation where a company whose stock is priced at $200 per share and whose customer transactions typically are on the order of several dollars. It could take a very long time for a customer to earn enough rebates or credits to reach one share of stock. In addition, because the price of a share of stock fluctuates with the market, the customer is faced with a moving target. Consider a customer who is about to reach his goal in that he has accumulated $195 worth of credits toward a $200/share stock. But before he makes his next purchase, the stock jumps to $210/share. Instead of being $5 away from converting his credits into stock, he is now $15 away. Indeed, if stock market gains outpace the rate at which he earns credits, he will never reach his goal. See, e.g., U.S. Pat. No. 5,233,514, which describes a system enabling a consumer to purchase a product from a participating manufacturer, remove the UPC label from the packaging, and send it to a processing center to earn credits for that manufacturer. For each consumer, the system uses a computer file to keep track of the credits that the consumer has earned for each participating manufacturer, and then issues a buy order for one or more shares of stock when the consumer has accumulated enough credits in a particular manufacturer to equal or exceed the current stock price for that manufacturer.

Accordingly, there is a need for a system and method for enabling one or more companies to award an arbitrary amount of company stock to customers as an incentive, regardless of the company's share price.

In one embodiment, a customer may visit a provider's website to view a list of participating merchants and the amount of stock that can be earned from each merchant (e.g., $5 of merchant A's stock for any purchase of $50 or more from merchant A, 4% rebate of merchant B's stock for any purchase from merchant B). The dollar amount of the stock that may be earned by the customer may correspond to an integer or non-integer number of shares (e.g., 2 shares, 0.25 shares, 4/3 shares, π shares) of the merchant's stock. Upon signing in at the provider's website, the customer may click on a hyperlink to shop at a particular merchant's website. Once the customer makes a purchase, the link may be used by the merchant to identify the provider's site as the source of the customer who made the purchase, and to direct payment of the rebate to the provider in the form of cash. The provider may use some or all of the cash rebate to credit a customer account with a corresponding dollar amount of stock, which thereafter may fluctuate with the market price for the stock. The customer account may hold more than one stock, e.g., those that have been earned by shopping at multiple merchants.

In another embodiment, a customer need not visit the provider's website before earning a stock-based loyalty award at a merchant website. Instead, the customer could start at the merchant's site, and once a purchase has been made, the merchant may send the provider information identifying the amount of stock that the customer has earned. If the customer already has an account with the provider (which may be determined by looking up account information in the merchant's database or by obtaining it from the customer at the time of the purchase), the amount of stock being awarded may be credited to the account. If not, the provider or merchant may direct the customer to the provider's website to create an account to receive the stock award. By way of example, this may be done by sending the customer an email with a hyperlink that the customer clicks on to be redirected to the provider's website, open an account, and claim her stock award.

In another embodiment, the provider may keep track of rebates as they are earned, and convert them into stock periodically or after they have reached a sufficient level. For example, the provider may credit all customer accounts with appropriate amounts of the merchants' stocks on a particular day of the month (e.g., the first trading day of the month), based on the rebates that customers earned from the merchants in the prior month. Or, a customer's account may be credited with shares of a merchant's stock when the customer has earned a sufficient amount of rebate from that merchant (say, ten dollars' worth). As yet another alternative, the provider may monitor the aggregate rebate amount earned by each customer from all merchants. Once the aggregate amount for a customer reaches or exceeds a threshold (say $25), the provider may credit the customer's account with corresponding dollar amounts of the stock of every merchant from which rebates have been earned, regardless of how much rebate may have been earned from any given merchant.

In another embodiment, some or all customer accounts may be held by a third party, such as a separate brokerage firm. In this case, the provider may function as an intermediary that coordinates and processes rebates and stock awards that may end up in a customer's account with a third party brokerage.

In this manner, the systems and methods of the present disclosure enable customers to earn stock in a company as they make purchases at a company. The more the customer patronizes a particular company, the more stock he stands to earn in that company, not in a collection of companies that could include a competitor. The use of fractional shares decouples a company from its share price, thereby making stock awards practical despite market fluctuation, and practical even for companies with high share prices relative to typical purchase amounts. The use of a centralized provider account for all stocks that have been earned promotes convenience for the customer, who does not have to check multiple rewards accounts to keep track of all the stock he is earning. It also benefits merchants, because a customer may see all of his stocks (and thus may be continually reminded of all of the merchants he has patronized) every time he checks his account to see the stock he has earned from any merchant or to see how his stock is doing.

### BRIEF DESCRIPTION OF THE DRAWINGS

FIG. 1 is a simplified block diagram of one embodiment of the present disclosure.

FIGS. 2A-2F illustrate one embodiment of a provider database and its contents.

FIG. 3 illustrates a simplified flow diagram of one embodiment of a method for earning a loyalty award online.

FIG. 4 illustrates a simplified flow diagram of one embodiment of a method for crediting a customer with a loyalty award.

FIG. 5 illustrates a simplified flow diagram of one embodiment of a method for generating an award identifier for a customer.

FIGS. 6A and 6B illustrate a simplified flow diagram of one embodiment of a method for claiming an award associated with an award identifier.

FIG. 7 illustrates a simplified flow diagram of one embodiment of a method for controlling the provider's inventory of publicly traded shares.

FIG. 8 illustrates one embodiment of a compensable action matrix.

### DETAILED DESCRIPTION

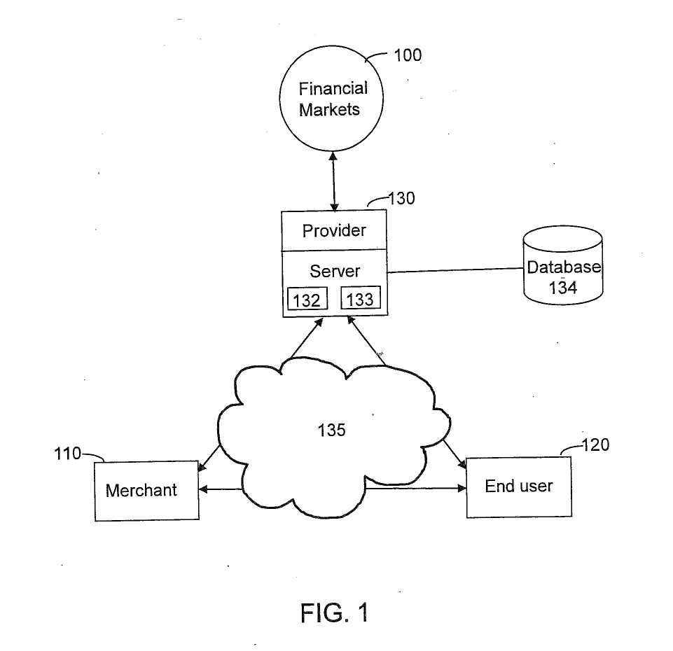

FIG. 1 shows a block diagram of one embodiment of the present disclosure. A merchant 110, end user 120, and provider 130 may be coupled to and communicate over a network 135 such as the Internet, by telephone, or otherwise. (Herein, we refer to end users 120 as “customers,” “users,” “end users,” or “recipients.”) Provider 130 may be equipped with a server that hosts a website 132 having one or more webpages, runs software 133, and accesses a database 134. Provider 130 also may be coupled to and communicate with financial markets 100 in which shares of stock are publicly traded. The provider may be a brokerage house, a clearinghouse, a financial or investment advisor or a third party provider that ensures compliance with all regulatory requirements and facilitates establishing the required brokerage accounts and transferring awarded securities to the designated recipient.

Merchant 110 may have one or more physical locations and optionally may have a website with one or more webpages. The merchant also may maintain a database. Merchant webpages may list or display goods and services that may be purchased by an end user visiting the site.

End user 120 may use a personal computer, tablet computer, smart phone, or other device to connect to the network 135. End user 120 may visit provider website 132 to sign up for a provider account, view a list of merchants where loyalty awards may be earned, make purchases or take other compensable actions, or view the loyalty awards that have been earned. End user 120 may query provider database 134 to view the performance of her stocks, place a sell order for some or all of her holdings, or buy more stock. Although FIG. 1 depicts only one merchant and one end user, in general there may be a plurality of each.

Provider 130 may operate as an introducing broker that maintains (e.g., in conjunction with a clearing firm) a brokerage account for each end user. The account is centralized in that the stock earned from any merchant may be credited to that account, so that the user need not log in to multiple siloed accounts to check all of his stock awards.

For any given merchant, the loyalty currency that is awarded may take a variety of forms. For example, for a merchant that is a public company, the company's own stock may serve as the award. For a merchant that is not a public company, another asset may be used (e.g., the stock of another public company, such as the manufacturer of the product that was purchased if the merchant is a retailer, or an ETF that emulates a market index, such as S & P SPDRs). Moreover, the loyalty currency that is associated with a merchant may be selected by a variety of entities, including, for example, the merchant, the provider, or even the customer.

The amount of the award also may vary depending on which entity makes that determination. For example, the merchant may compute the amount of the award and instruct the provider accordingly. Or, the merchant might notify the provider of the customer's action and direct the provider to compute the amount of the award, if any. Or, the provider may determine how much of an award to give the customer, an amount that may depend on how much compensation the provider receives from the merchant. Or, the customer may decide how much of a conventional loyalty currency (e.g., rewards points, credits, cash, etc.) she would like to convert into a stock award.

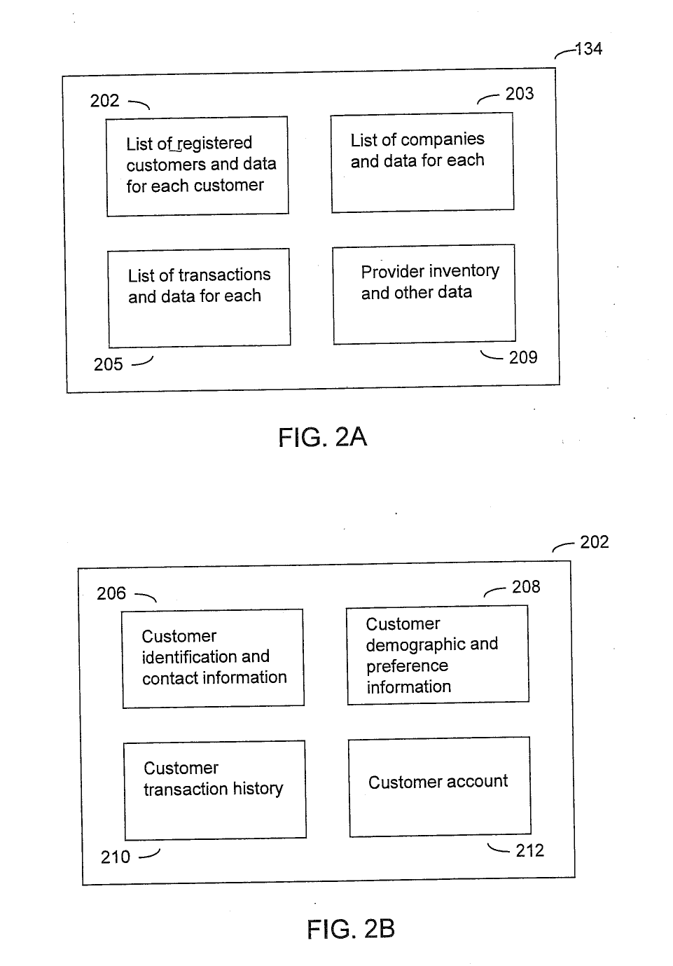

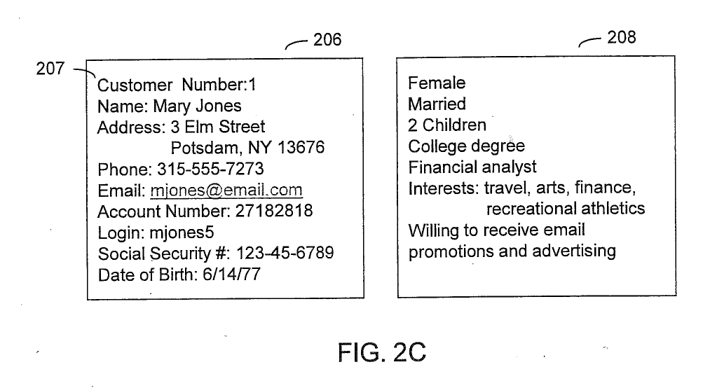

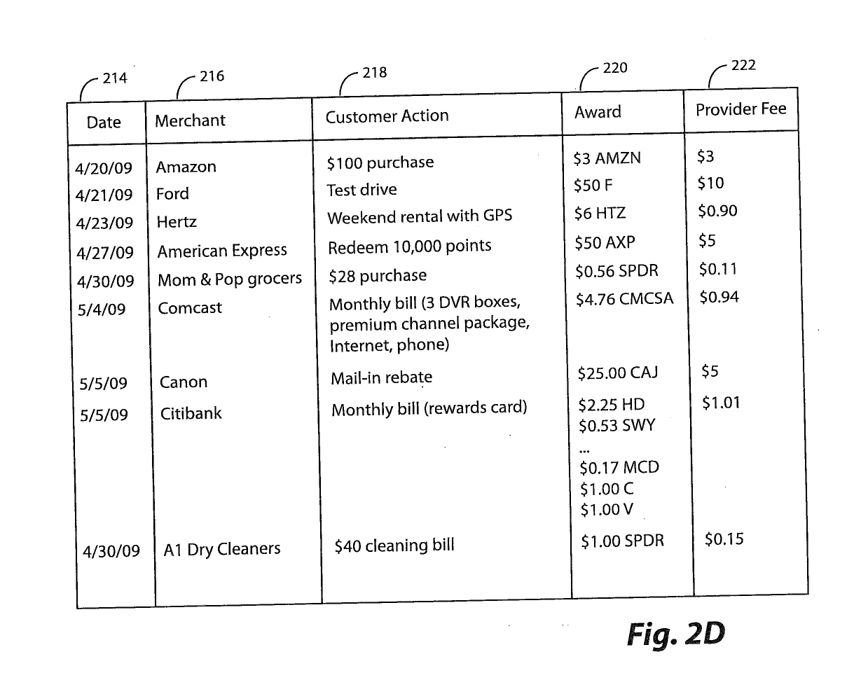

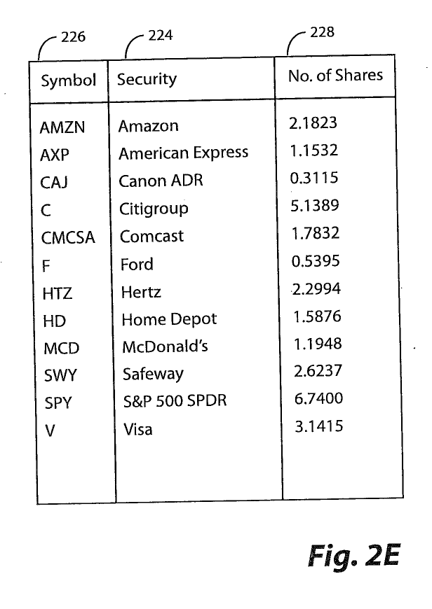

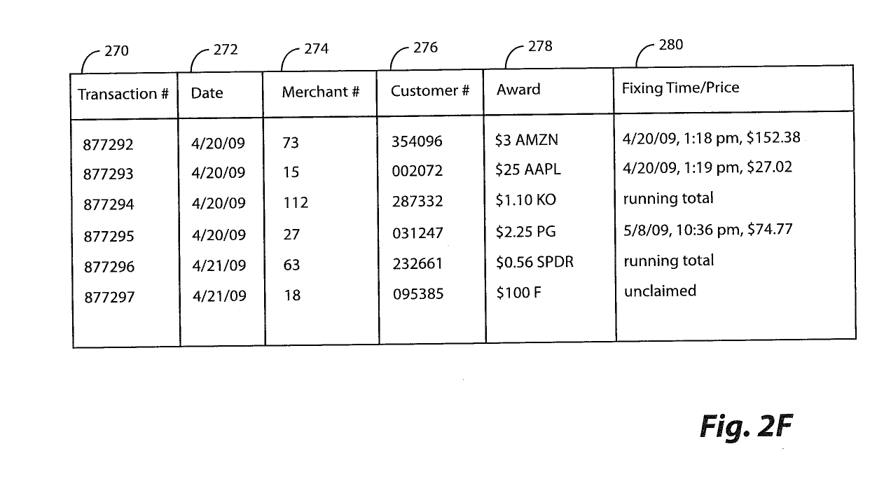

Referring to FIG. 2A, provider database 134 may store various kinds of information. This may include information about (a) customers who have registered with the provider 202, (b) participating merchants 203, (c) system transaction history 205 (shown in greater detail in FIG. 2F); and (d) the provider's inventory of stock 209.

As shown in FIG. 2B, list 202 of registered customers may include more detailed information for each customer:
206: customer identification and contact information (e.g., customer number 207, account number, name, address, phone number, email address, social security number, date of birth, login name and password, etc.) as shown in greater detail in FIG. 2C;
208: customer demographic and preference information (e.g., sex, marital and family status, education, occupation, interests, preferences regarding desire to receive advertising and promotions, trading experience, etc.), as shown in greater detail in FIG. 2C;
210: customer transaction history, including transaction date 214, merchant 216, customer action 218, award amount 220 (in the form of, e.g., dollar amounts, number of shares, etc.) and provider fee 222, if any, for each transaction, as shown in greater detail in FIG. 2D;
212: customer account summary including, as shown in greater detail in FIG. 2E, list of all securities held 224, corresponding trading symbol 226, and number of shares 228. Optionally, if the numbers of shares are rational numbers, it may be convenient to refer to the number of “microshares” that corresponds to a particular number of shares. For example, if 2.345 shares are held, it may be convenient to refer to that amount as being equivalent to 2,345 microshares, where a conversion ratio (in this example, 0.001) or its reciprocal establishes the relationship between the numbers of microshares and shares,

Some of the information may be specified by the customer or assigned by the system during initial registration, while other information may be recorded after transactions at the provider's website, or computed using other information in the database and/or external data sources. Some information in database 134 also may be maintained by some or all of the merchants. For example, merchants may wish to have a database that includes the subset of information in FIG. 2D that pertains to that merchant. Or, merchants may be provided read access to portions of provider database 134 that pertain to them.

Similarly, various items in database 134 may be viewable by registered customers. For example, customers may view the list of merchants and information in the database for each merchant, as well as information regarding the customer's own identification, demographic, transaction, and account information 206-12. Such queries may take place at the provider website 131 via, e.g., user interfaces that may include form fields, radio buttons, and pull-down menus. Some portions of the database, such as the list 203 of participating merchants, may be viewed by non-registered and registered customers

The foregoing description of database 134 is merely illustrative, and a person skilled in the art will appreciate that there are many other ways of obtaining and organizing the information, and that additional or other types of information could be used.

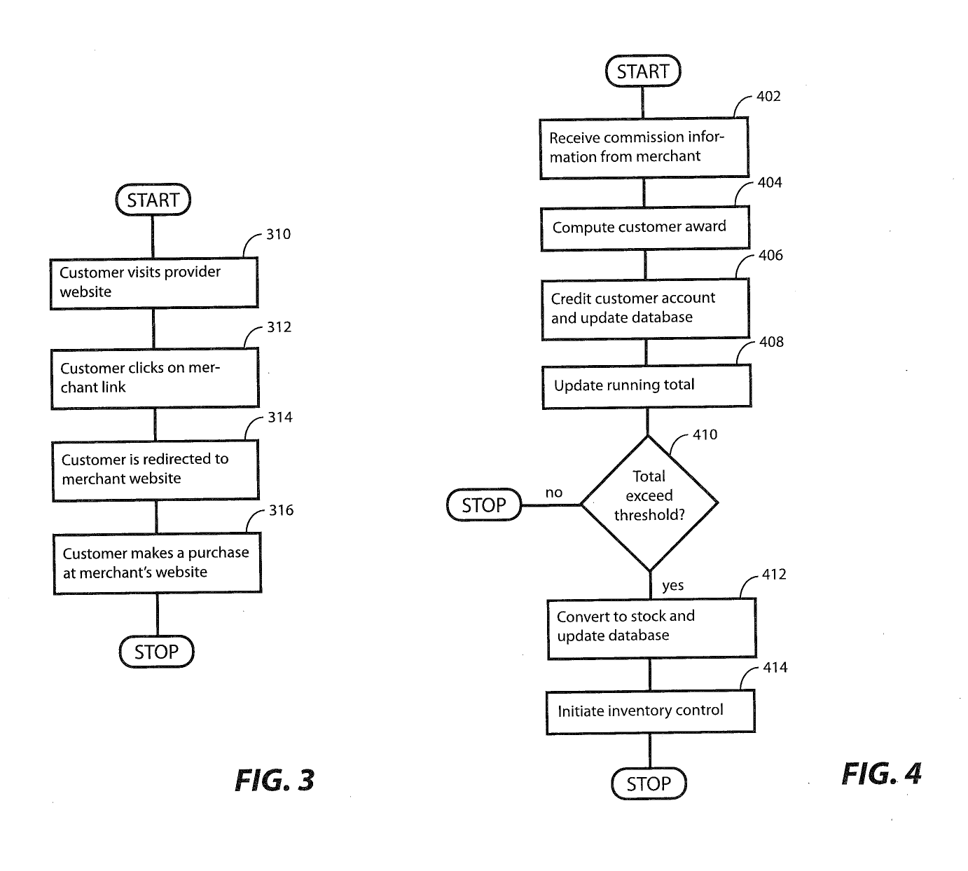

The awarding of stock to customers is now described in connection with FIGS. 3 to ______, and may occur using any of a variety of mechanisms depending on the merchant's relationship, if any, with the customer and the provider, the nature of the merchant's business, available infrastructure, and other considerations. Many of these mechanisms overlap in various ways, and a set of illustrative examples is provided here.

In one embodiment, there need not be a preexisting customer/merchant relationship. For example, it may be desirable to award stock to a customer who makes an online purchase at an online merchant but is not a member of the merchant's loyalty program or otherwise registered with the merchant. Referring to FIG. 3, in step 310, a customer may visit the provider website to learn about opportunities to shop and earn stock. The website may include a list of merchants that are categorized in various ways (e.g., alphabetically, by industry, favorites, etc.) that are displayed in the form of search results (e.g., the results of a search of merchant websites for an item desired to be purchased) along with an indication of how much stock can be earned for various customer actions. For example, the provider website might specify a 3% award of Amazon stock for any purchase made at www.amazon.com, a $25 award of Target stock for signing up for a co-branded VISA card, or other compensable action/award pairs. In step 312, a customer browsing these offers may click on a merchant link to be redirected to that merchant's site in step 314. Once at the merchant website, the customer may make purchases or take other compensable actions (step 316).

Information about the award earned by the customer subsequently may be sent to the provider so that the award may be processed and credited to the customer's account. This may occur periodically (e.g., once a month), or following individual customer purchases. One such embodiment is described in connection with FIG. 4.

In step 402, the provider receives rebate information from a merchant. In one embodiment, the rebate may take the form of an affiliate commission, whereby a merchant (such as Amazon) pays a referral fee to an affiliate (such as the provider) in accordance with negotiated or published rates. For example, under Amazon's affiliate program, a certain percentage (e.g., 5%) of every purchase made by a customer who was referred from the provider's website to Amazon's website may be paid to the provider. In step 402, the merchant (or a third-party vendor acting as a middleman between the merchant and provider) notifies the provider of the commission earned by the provider as a result of the customer's purchase. Then, in step 404, the provider may compute the amount of the rebate that should be awarded to the customer and credit the customer's account with that amount in step 406. (The step of crediting the customer account may occur before or after the provider receives payment from Amazon.). In the example discussed above, where Amazon pays the provider 5% of every referred purchase, the provider could keep, e.g., 2% of the 5% rebate as a provider fee 222, and pass on the remaining 3% to the customer. The 3% pass-through would be in accordance with provider's website having specified in step 310 that customers earn a 3% rebate of Amazon stock for any purchase made at Amazon. Thus, a customer who spends $100 at Amazon would earn $3 of AMZN stock, as shown in the first row of the table in FIG. 2D.

In another embodiment, the merchant determines how much of the total payout is awarded to the customer, instead of the provider doing so as in the context of an affiliate relationship. For example, an online bank may designate an award of $25 of the bank's stock to customers who open a new account. In this case, the entire $25 is credited to the customer's provider account in step 406, and the provider fee, if any, may be assessed separately.

Following step 406, the system converts the customer award into stock if it is big enough to be converted. That is, for small awards, it may be economically infeasible to convert the award into an equivalent amount of stock because of various costs associated with the purchase of the stock (e.g., trade settlement, creation of a trade confirm, maintaining a record of cost basis, etc.). Thus, in step 408, the award may be added to a running total, if any, of previous awards from the merchant that, even aggregated together, were too small to have been converted into stock. The new total dollar amount resulting from step 408 is compared to a predetermined threshold in step 410.

If the threshold is met or exceeded, in step 412 the new total is converted into stock by placing a buy order for that amount of stock from the provider's inventory account 209. For example, if $10 is applied to the purchase of a stock trading at $50/share at the market close on Apr. 19, 2009, the customer's account would be credited with 0.2 shares of that stock. The provider's records would also reflect a “fixing time” of Apr. 19, 2009 at market close, and a “fixing price” of $50/share, for the transaction. Inventory control then may be initiated in step 414 to determine whether the provider's inventory needs to be replenished.

On the other hand, if the threshold is not met, the total resulting from step 408 is not converted into stock, but is stored in database 426 until the next award from the same merchant is earned, at which time the new running total is compared to the threshold in step 408.

Another embodiment in which there need not be a relationship between the customer and merchant is where the merchant supplies a widget on its website to enable customers to earn awards of stock through the provider. In this case, even if the customer did not visit the provider's website before making a purchase at the merchant's website, the customer could still click on the widget (e.g., at checkout) to log in to her provider account, or sign up for a new account. Once the customer is logged in to her account, the merchant has the information needed to send award information to the provider in accordance with step 402 of FIG. 4, and subsequent processing may take place as described above starting with step 404.

Another example of an embodiment where no preexisting customer-merchant relationship is needed is where the merchant uses an award identifier to enable the customer to claim a stock award at the provider's website. In this case, once the customer takes a compensable action, the merchant may communicate the award identifier to the customer by printing it on a sales receipt, emailing it to the customer, or in other ways. The customer may then enter the identifier at the provider's website to claim the stock award. For example, a car rental company like Hertz could include an award identifier at the bottom of the receipt that is printed and provided to the customer when the car is returned. The customer would then enter the award identifier at the provider's website (or communicate it to the provider in other ways, e.g., by texting it, calling the provider by phone, etc.) to claim the stock award (see, e.g., the third row of the table in FIG. 2D). Alternatively, the award identifier could be in the form of a bar code or some other machine readable form. The customer could communicate the award identifier to the provider by scanning the bar code using a smart phone and transmitting this information to the provider.

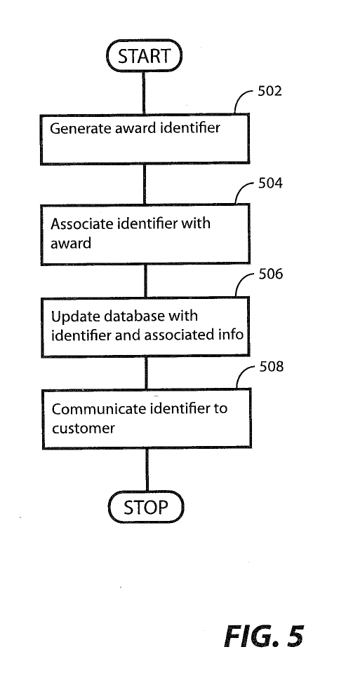

The process of generating an award identifier is now described in connection with FIG. 5. In step 502, the provider may generate one or more award identifiers using, e.g., a pseudorandom number generator or other algorithm. The number generator should be designed to produce identifiers that have a sufficient number of digits and are sufficiently hard to predict given knowledge of other valid identifiers. That is, a random attempt to guess a valid identifier should fail with sufficiently high probability. Additionally, it might be preferable to choose the length or other format of identifiers so as to facilitate other processing. For example, a sixteen digit number may be useful for easier integration into an existing credit or debit card infrastructure. Also, it is noted that the identifier need not be purely numeric. Its digits may consist of or include letters of an alphabet and/or other characters or symbols. Award identifiers may be generated ahead of time by the provider and supplied to the merchant, generated on the fly as when requested by the merchant, or generated by the merchant using hardware and/or software supplied by the provider.

In step 504, the identifier is associated with the dollar amount of the customer award. (If the merchant performs step 504, the association is communicated to the provider. If the provider performs step 504, the award amount will have been communicated from the merchant to the provider.) In step 506, the provider may update transaction history 205 in FIG. 2A with the award identifier, associated award amount, and any other information that will be needed by the customer to claim the stock. In step 508, the identifier may be incorporated into a communication from the merchant to the customer, e.g., printed on a sales receipt, sent by email, etc. The information printed on the sales slip or appearing in the email might read, for example: “Enter the code YT67N-HW9K3 at the website www.provider.com” to claim $3.27 of stock in Company A.”

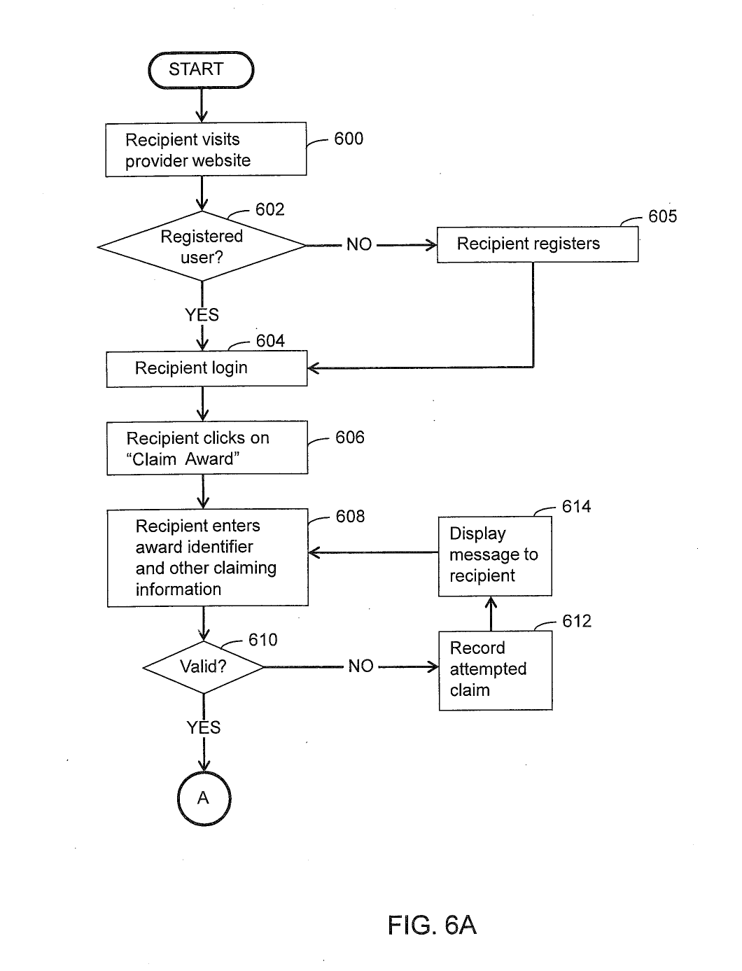

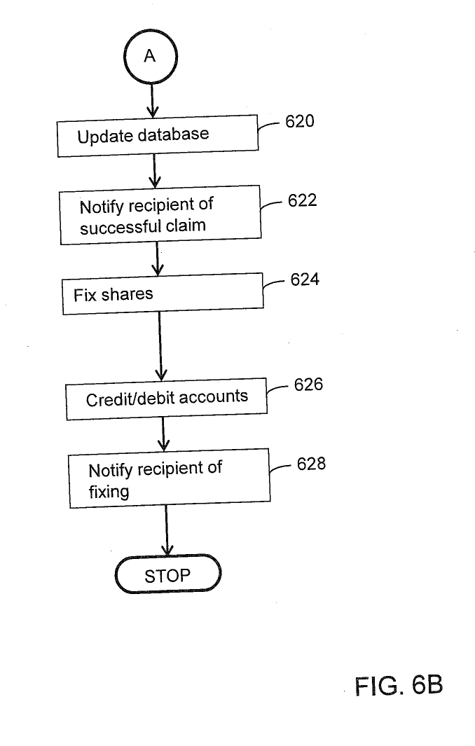

The customer then may use the identifier to claim her stock award. Referring to FIG. 6, once the customer visits provider website (step 600), if she is a registered user (as tested in step 602), she logs in by entering a customer ID and password in step 604, so that her account and other information may be accessed. If she is not a member, she may be required to register (step 605). Requiring the recipient to register as a member before claiming may promote increases in the provider's membership. However, it may be preferable not to require the recipient to provide more information than is needed at the time of claiming (e.g., information that may not be needed until shares are sold) to avoid deterring the recipient from registering. It also may be desirable to defer registration of the recipient until after she has entered the information needed to claim the stock (e.g., after step 610).

In step 606, the customer clicks on the link labeled “Claim Award,” and then in step 608 enters the award identifier, and may enter, select, or otherwise designate other claiming information such as the dollar amount of the award or the name of the merchant giving the award. Provider 130 then compares the entered information with the transaction information stored in its database 205. If there is a match, as tested in step 610, the attempted claim may be determined to be valid. If not, the attempted claim may be recorded in step 612, and an error message may be displayed in step 614 inviting the customer to enter the correct information. Further actions, such as disabling additional claim attempts, also may be taken in step 612 if, for example, invalid information has been entered a certain number of times.

The unpredictability of valid award identifiers (e.g., given knowledge of other award identifiers) makes it highly unlikely for someone to claim a valid award by randomly picking a number or character string and entering it into the system. This is especially true to the extent the system may monitor and record unsuccessful claim attempts (in step 612), and only registered users are permitted access to the webpage where claims are made (step 604). This unlikely possibility, however, is made even more remote by requiring the customer to enter additional claiming information, such as the merchant name or dollar value of the award, in step 608. Now, a third party attempting to defraud the provider would not only have to guess a valid award identifier, but also the merchant name and dollar amount that go with it.

With reference to FIG. 6B, if the customer successfully enters all required information, database 205 may be updated in step 620 to reflect that the award has been successfully claimed. The customer in step 622 then may be notified that the award was successfully claimed. If thresholding is being used, then the award amount may be converted to stock if it (together with any previous running total) exceeds the threshold. The customer also may be given an option to choose some other asset (e.g., mutual fund shares) or item other than stock (e.g., a conventional merchandise gift card) that is offered by the merchant.

Once the provider fixes the number of shares (step 624), the customer's account may be credited with the appropriate number of shares, and another account (e.g., the provider's inventory account) may be correspondingly debited by the same number of shares (step 536), and the customer may be notified in step 538 that fixing has occurred. The number of shares that are credited to the customer's account may be a non-integer number.

Instead of taking the form of an alphanumeric code or other character string, the award identifier instead may take the form of a hyperlink to a webpage where an award may be claimed. Upon receiving from the merchant the amount of an award, the provider system may create a hyperlink that is specific to the award. The link may be encrypted to promote security and prevent fraud. The provider system uses additional information provided by the merchant, such as the customer's email address, to email the hyperlink to the customer. Upon receiving the email, the customer may make a request to claim the award by clicking on the link, which results in displaying to the customer a webpage where the associated award may be claimed. An appropriate amount of stock may be credited to the customer once she provides account information, e.g., by logging in to her existing provider account or opening a new provider account, and provides any other claiming information (e.g., enters her phone number) that is required. Thereafter, the correct amount of stock may be credited to the customer's account as described above. (If thresholding is being used, the customer's account will be credited with stock if the new running total meets or exceeds the threshold. Otherwise, the account will reflect the new running total as a pending credit that is good toward conversion into stock once more credit is earned.)

This alternate embodiment enables the claiming of an award by clicking on a link in the email instead of having to enter an identifier that might be a relatively long string of characters. For example, if a customer test drives a Ford pickup at the local dealership, the dealer could provide the customer with a card that includes an alphanumeric award identifier good for, say, $50 of Ford stock (see 2nd row of transaction history 210 in FIG. 2D. Or, if the dealer has the customer's email address, an identifier in the form of a hyperlink may be emailed to the customer (by the provider or the dealer). The customer would then click on the hyperlink to claim her stock, which might be more convenient than having to type in an alphanumeric identifier.

Alternatively, the merchant could send an email that provides the hyperlink directly to the customer. Several embodiments for this are possible depending on the type of relationship that exists between the customer and the merchant and the nature of the transaction. At the point of sale, the customer could provide her email address to the merchant. Or, if the merchant has a preexisting relationship with the customer then merchant may already have the customer's email address. In this case, once the customer is identified, the customer's email address could be automatically looked up. Identifying the customer could be done automatically through other information (e.g., name and address, credit card information, phone number, account number) that the merchant may receive as part of the transaction. Or, the customer could be asked to provide some additional information such as a phone number or account number in order to look up the customer's email address.

Another embodiment enables providing stock awards in the context of a mail-in rebate. After purchasing a product, a customer may fill out a rebate form and submits it for processing along with any other required items, such as proof of purchase, original sales receipt, etc. A rebate processing center processes the rebate submission. Once the validity of the submission has been verified, the processing center mails, emails, or otherwise communicates an award identifier to the customer (e.g., in the form of an alphanumeric code as described in conjunction with FIG. 5, a hyperlink embedded in an email as described in conjunction with FIG. 6 by posting to a website, or in some other way). The customer then may claim the stock award in the manner described above.

This mechanism might be useful in scenarios where a mail-in rebate traditionally is offered. For example, if a customer purchases a Canon digital SLR camera, Canon could offer the customer a manufacturer's rebate good for $25 cash or $25 of Canon stock (see the 7^{th} row of transaction history 210 in FIG. 2D).

Another embodiment enables providing stock awards contained within the packaging of an item that is purchased in situations when the item cannot be returned after being opened. For example, an award identifier (a.k.a. “claim code”) could be placed inside a breakfast cereal box so that after the cereal box is opened the claim code can be obtained. Another example is to place a claim code on the underside of a bottle cap or inside a bag of snacks.

Instead of awards that are fixed and known in advance, another possibility is to introduce variations or randomness in the awards or not have the award amount known in advance. This may be used to replace many small awards with occasional large awards. It may also be used to introduce some excitement or surprise for the customer due to chance. For example, on the underside of the bottle cap could be an indication of whether or not an award was won and the value of the award, together with a claim code for obtaining the award. Similarly a notification could be placed in the cereal box regarding the amount (if any) of an award and information on how to claim the award. Yet another possibility could be to give claim code information but to have the award amount (or even whether the claim code is a winner with an award vs. a loser with no award) disclosed to the customer at the time of claiming. In this case, the award amounts need not be determined at the time of packaging but could be determined at a later point in time up to and including the time of claiming. Such a scheme can allow adaptively setting the award amounts based on the amount of awards given up to a certain point or on other factors.

In another embodiment, a game piece is provided when a customer takes a compensable action, such as buying a particular menu item, spending a certain amount of money at the merchant, paying a certain amount of money for an item that comes with a game piece, etc. The game pieces could be made so that by scratching off a portion of the game piece, the amount of the award (if any) is revealed. Or, the game pieces could be made so that getting the right number or right combinations of multiple game pieces could determine whether or not an award is received and the amount of the award. Whether or not a game piece or combination of game pieces results in an award and if so the amount of the awards could be determined at a time up to and including the time the customer redeems the game pieces.

Another embodiment is to allow a customer to redeem airline miles or reward points from other programs for stock. Many reward programs allow customers to redeem points in the reward program for merchandise, travel, or other awards. The possibility of redeeming points for stock could be added as a redemption option in these programs. For example, FIG. 2D shows an entry dated Apr. 27, 2009 for the merchant American Express. The entry shows that the customer redeemed 10,000 American Express points for $50 of American Express stock.

In one embodiment, the customer visits the website of the airline, merchant, or third party that runs or sponsors the award program. At the website, the customer selects the number of points to be redeemed and the dollar amount of stock to be received from among the options available. The merchant then submits information to the provider about the customer and the award, and the provider credits the customer's account accordingly with stock or a credit that is convertible into stock once a running-total threshold is reached. Alternatively, the merchant could provide the customer with a claim code (by mail, email, or other means), which the customer could use at the provider's website to claim the award.

In an alternative embodiment, the customer visits the provider website, specifies the merchant loyalty program from which he would like to redeem points, and selects the number of points to be redeemed. The provider then credits the customer's account with the stock and deduct the appropriate number of reward points from the customer's reward point account, or the provider communicates the information to the merchant, which then deducts points from the customer's rewards account.

Various parameters associated with this embodiment may be determined by the merchant, the provider, or the customer. For example, the merchant might determine the number of reward points that can be redeemed and the associated dollar amount of stock that will be received. Or, the merchant may set several reward point amounts each with an associated dollar amount of stock and allow the customer to select among these. Another possibility is for the merchant to set a conversion ratio from points to dollar amounts of stock or set a set of tiered conversion ratios, and allow the customer to select the number of reward points they wish to convert so that the dollar amount of stock received by the customer will depend on the number of points selected and the applicable conversion ratios. In another implementation, the customer may select a standing redemption option with the merchant or the provider. Reward points can be converted to stock periodically as points are earned, or each time a threshold of points is reached by the customer. In yet another embodiment, the customer may indicate that she would like points to convert to stock automatically whenever the price of the underlying stock hits a specified value or changes by a specified amount, along the lines of, e.g., a limit order. These selections may be made with the merchant or the provider, with the merchant and provider exchanging information as necessary to carry out the redemption.

In another embodiment, stock awards may be given where the customer and the merchant have an ongoing relationship. The amount of the stock award may depend on the customer's activity with the merchant during the account period, for example the total amount of a bill, the amount spent on premium services or particular purchases, etc. FIG. 2D shows an entry dated May 4, 2009 for the merchant Comcast. Based on the monthly bill, the customer earned $4.76 of Comcast stock.

In one implementation, if the merchant sends periodic account statements to the customer as part of their ongoing relationship, the merchant may inform the customer of the amount of stock awarded to the customer in each period as part of the periodic account statement. Alternately, the merchant may notify the provider of the awards for each of the merchant's customers. The provider may then credit each customer's provider account with the appropriate amount of stock. If a customer does not have an account with the provider, then on the statement the merchant sends to the customer, the merchant may notify the customer that she could start earning stock by opening an account with the provider.

In another embodiment, the merchant may inform the customer of how much stock they may earn for activity during the most recent period, but the customer may be required to take an additional action for the stock to be credited to his account. For example, the customer may be required to log into the provider account and claim the stock earned, perhaps along with entering some required information

In yet another embodiment, the merchant may send information about awards for each customer in the most recent period, and the provider may notify the customer of the award by email or by a message provided to the customer when she logs into her provider account.

Many variations are possible regarding the amounts of the award. As mentioned, the award amount could depend on the customer's activity with the merchant during the account period, or the amount spent on premium services or particular purchases. Also, the award amount could depend on customer activity over several consecutive billing periods, or the length of time the customer has had an account with the merchant, or for specific activities or situations such as upgrading to a new level of service, renewing a contract, compensation for loss of service, etc.

Another embodiment enables awards of stock through use of a credit card. The provider could partner with a card issuer (e.g., Chase or Citibank) or card network (e.g., MasterCard, Visa, Amex) so that purchases made using the card result in stock awards. The amount of the stock award may depend on the customer's use of the card in a given period, for example the total amount of a bill, the amount spent on qualifying purchases, etc. Awards could be provided by the network, by the issuer, by merchants where purchases of goods or services were made, by the provider, etc. The awards could be for stock in the network, the issuer, the merchants where purchases were made, the provider, or some other asset (e.g., an exchange traded fund). For example, FIG. 2D shows an entry dated May 5, 2009 where the merchant is Citibank. Based on the monthly bill, the customer earned stock in a variety of merchants including $2.25 in HD and $1.00 in V.

In one embodiment, the credit card issuer may send information each month to the provider on the awards earned by each card holder, and the provider may credit the accounts of these customers accordingly. The customers may be notified of the awards earned on their credit card bill, by an email to the customer, by a message when the log into their provider account, by viewing their account portfolio or activity, etc. Customers that do not have an account with the provider could be informed of their opportunity to earn stock on their credit card statement, by an email, etc.

Another embodiment enables awards of stock through the use of merchant loyalty cards or programs. The provider may partner with a merchant so that points, awards, or credits earned on a loyalty card or part of a loyalty program may be redeemed for stock. The stock may be in the company running the loyalty program, a partner, a different company, or in some other asset (e.g., an exchange traded fund). The amount of the stock award may depend on parameters set by the merchant running the loyalty program, parameters set by the provider, or selections or activities on the part of the customer.

In another embodiment, the merchant running the loyalty program may send information regarding redemptions to the provider, and the provider may credit the account of the customer as appropriate. Alternatively, the merchant and provider may arrange to allow customers to redeem the values on their cards with the provider. Another possibility is to allow the customer to provide information at the point of sale, for example with a loyalty card, providing a phone number, etc. This information may be accrued by the merchant and sent to the provider periodically or could be sent directly to the provider. Yet another possibility is to allow customers to turn in punch cards once enough punches have been accrued in exchange for a claim code that can be used at the provider website to obtain stock. For local retailers or other merchants that are not publicly traded, the stock could be in the form of an exchange traded fund or other asset, or in a company that is chosen by the merchant, the customer, or the provider, etc.

The fractional shares of stock held by provider's customers may be covered by integer shares that are bought and sold by the provider. The provider may cover the fractional holdings of its customers by maintaining an inventory of shares, and assigning fractional shares from this inventory to a customer, e.g., when a loyalty award is earned, or transferring fractional shares from a customer to its inventory, e.g., when a customer sells some stock. Restocking the provider's inventory with integer share street-side trades and then allocating fractional shares from the inventory to customer accounts can provide significant cost savings compared to transacting street-side trades for individual customer transactions.

For regulatory, risk management, or other purposes, the provider may wish to monitor and control its inventory 209 (see FIG. 2A), i.e., the number of publicly traded shares that it owns in each company in which the provider's customers may own shares. This may be done by monitoring the aggregate number of shares owned by customers and the number of publicly traded shares held by the provider, and buying or selling shares on the open market (or some other way, such as directly to or from the company) as appropriate.

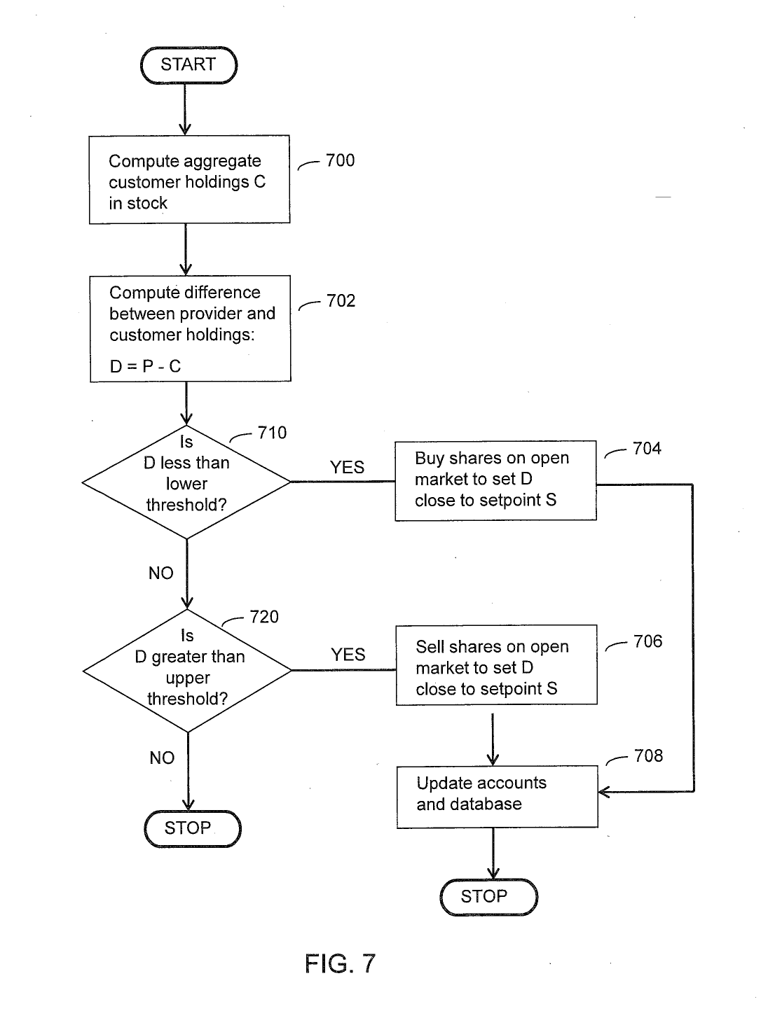

For each company, inventory control may be accomplished in accordance with a process such as that shown in FIG. 7. After stock in the company has been claimed by a customer who is an award recipient (or bought or sold by a customer for his own account outside of the context of loyalty awards), in step 700, a computation may be done to compute the aggregate number of publicly traded shares, C, that will be held by customers after the current award/redemption request is completed. This may be done by adding together the number of shares held by each customer to find the total number of shares C. Then, in step 702, the number of shares currently held by the provider, P, is determined from the database 209, and the difference, D, between the holdings by the provider and the number of shares to be held by customers is computed as D=P−C.

This difference D is compared in step 710 with a lower threshold T_{L}. This lower threshold may be selected by the provider based on regulatory requirements, risk management preferences, and other factors. If D<T_{L}, as tested in step 710, the provider buys shares on the open market so that after the award, the difference D will be non-negative and sufficiently close to, or a desired distance away from, a set point S (step 704). The set point S also may be selected by the provider based on regulatory, risk management, and other factors. Then, in step 708, the provider database 209 and accounts are updated to record the transaction and reflect the change in holdings.

If D is not less than T_{L}, as tested in step 710, then another test is made in step 720 to see if D is greater than some upper threshold T_{U}. As with T_{L} and S, the choice of T_{U} may be made based on various regulatory, risk management and other factors. If D>T_{U}, the provider may sell shares on the open market such that D is non-negative and sufficiently close to, or a desired distance away from, set point S (step 706). In step 708, the provider database 208 and accounts are updated to record the transaction and reflect the change in holdings.

If D is not greater than T_{U} as tested in step 720, then D is within acceptable bounds and it may be determined that no shares need to be bought or sold on the open market.

The parameters T_{L}, T_{U}, and S may be different for each company in which customers and the provider hold shares. In addition to depending on regulatory requirements and risk management preferences, these parameters may depend on properties of the company and/or its stock price (e.g., stock price volatility, the company's industry group, whether the company is a recent issue, etc.), the balance sheet and other holdings of the provider (e.g., the amount of cash held, cash flow, amount of other stocks held, etc.), economic conditions (e.g., prevailing interest rates, etc.), or other factors.

For example, if it is the policy of the provider always to have all positions covered, then T_{L} may be set equal to zero. A check is made in step 710 to see if enough shares of the company's stock are currently in the provider's inventory 209 so as to cover the shares being purchased by purchaser 110 (i.e., D may be compared to 0).

Another alternative for inventory control is to make sure that after allocating shares to customers, the dollar value of the inventory held by the provider for a given stock is in a specified range between D_{L} and D_{U}. If customer claims would make the dollar value of the inventory fall outside of this range, then the provider can buy or sell shares on the open market to bring the inventory after fulfilling the customer claims within the range D_{L} to D_{U}. As before, the parameters D_{L} to D_{U} may depend on regulatory, risk management, or other factors. Also, the parameters may be different for each stock.

Other alternatives for inventory control are also possible. For example, individual buy and sell orders may be pooled or offset to reduce the number of trades on the open markets. This aggregation may take place periodically (e.g., daily). Or, orders may be sent directly for execution on the open market, or may be sent to a third party clearing firm. Yet another possibility is to introduce synthetic instruments to track the performance of the underlying stocks. Yet another possibility is to keep track of share allocations and corresponding account values without actually buying the securities or by buying and selling derivatives or futures contracts for hedging or covering purposes.

A customer may use the provider's system to view his or her account information. This may include, for example, the customer's personal information and account holdings 212 (see FIG. 2E), where the latter might include a list of stocks 224, corresponding symbols 226, and number of shares held 228, which when marked to the market yield the current market value of each holding (not shown). One or more of these items may be emphasized in different “views” of the account—e.g., a “dollar view” might emphasize how much of each stock a customer owns in dollars, whereas a “share view” might emphasize how much is owned in terms of number of shares (as in FIG. 2E).

The customer may view additional account information, such as a transaction history. Referring to FIG. 2D, the transaction history 210 may include a list of stock awards earned from various merchants. A list entry might include transaction date 214, name of awarding merchant 216, customer action 218, award 220, and provider fee 222. The example shown in FIG. 2D is based on an implementation without conversion thresholds, i.e., in which awards may be earned directly in the form of stock. On the other hand, if thresholds are used, the transaction history would instead show the dollar amount of awards that have been earned, conversions that have occurred, and amounts of stock that have been credited to the customer's account.

The use of fractional shares enables stock awards for customer transactions that might otherwise be too small to qualify for such an award. The use of thresholds and a running total (see, e.g., steps 408, 410 of FIG. 4) also facilitates stock awards for small transactions.

The threshold may be implemented in a variety of ways that boost the feasibility of stock awards for small transactions. In the description above, once the customer's running total (e.g., $10.57) for a particular merchant meets or exceeds a predetermined threshold (e.g., $10), that total may be converted into the merchant's stock (in this example, $10.57 of Merchant A's stock). Another alternative is to convert the threshold amount, but not the remainder. That is, $10 would be converted into stock, and the remaining 57 cents would end up as a new running total.

Other alternatives allow for interchangeability across merchants. For example, running totals could be aggregated over some or all merchants. If a customer had running totals of $2, $3, and $4 in merchants A, B, and C, and then earned an award of at least $1 from any of those merchants, all three amounts would convert into the respective dollar amounts (i.e., fractional shares) of stock in the three merchants. Similarly, running totals could be applied to the stock of companies other than the merchant who gave the award. For example, running totals for a first set of companies could be aggregated and converted into the stock of a second set of companies, with the two sets overlapping completely, partially, or not at all. It may be desirable to restrict interchangeability to certain situations. For example, interchangeability may be more compelling for a private company (which does not have its own stock) or a company that has a business relationship with certain other companies (e.g., a retailer that sells the goods of certain manufacturers).

Different merchants also could be allowed to have different conversion thresholds (e.g., $5 vs. $20). This may be useful, for example, where the typical award earned from one merchant is significantly higher than that for another merchant. Or, the threshold may be set differently for different people. For example, customers who achieve elite status may enjoy lower thresholds than others. Or, a bonus could be awarded if the customer chooses to wait until he reaches a higher threshold among several that are available. For example, a customer who elects to convert his running total into stock when he reaches $20 might be given $22 dollars of stock (a 10% bonus), but no bonus if he converts at a $10 threshold.

From a logistical or cost standpoint, it may also be desirable to convert running totals into stock at specific times, such as a particular day of the month. For example, on the first of every month, a scan could be made of every customer account to identify those accounts that have running totals that exceed the threshold. On that day, a mass conversion could take place, potentially reducing ticket charges of trades to the street and simplifying cost basis records, for example.

If thresholds are used, breakage opportunities may result for running totals that do not reach a threshold within a certain amount of time, or ever. Conversely, it may be desirable to allow customers to “top off” a running total by paying the difference between the running total and the threshold. For example, if a customer has a $7 running total for a merchant, he may be given the choice to pay another $3 to reach a $10 threshold and have his award convert into stock. Topping off would help customers avoid breakage or decrease the time it takes to convert their running total into stock.

Several implementation options also exist in terms of the time at which a running total converts to stock. In the description above, a running total automatically converts to stock once it reaches a threshold. Alternatively, the system could be implemented such that, once a threshold is reached, the customer is given some control over the fixing time or fixing price. For example, the customer could choose a later fixing time if she expects a decline in the market price of the stock in question. As another example, she might be allowed to place a “limit order, good 'til canceled” if she wants to delay fixing until the share price falls below a certain level. Or, as described above, conversions could occur only at certain prescheduled times (e.g., the 15^{th} day of the month).

Introducing a random component can also enable larger stock awards. For example, random bonuses could be given out at the time of conversion. Or, the merchant could give out game pieces where winning pieces are good for $1, $5, $25 or even $100 of stock and losing pieces are worth nothing Award amounts and frequency of winning could be set at a level such that customers feel they have a realistic chance of winning every time they make a purchase. Alternatively, the award amounts could be determined at the time of claiming the award and could depend on previous awards claimed, market conditions, a random component, or other parameters.

Another way to deal with awards that might otherwise be too small to convert into stock is to distribute award identifiers to a set of purchasers, but then split the total pot only among those who claim their award using the award identifier as of a certain expiration date. For example, a restaurant could deposit 1% of every customer's purchase into a pot, and give every customer an award identifier good for a portion of the pot to be determined. At the end of the week, the restaurant could distribute the pot among all of the identifiers that were claimed.

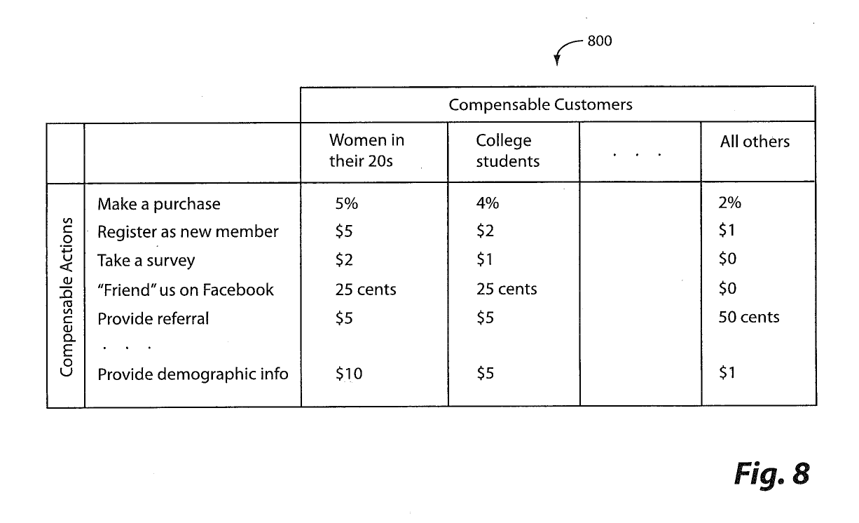

The award that is given out to a customer may vary depending on the profile of the customer, the compensable action taken by the customer, when the action was taken, and other parameters. For example, referring to FIG. 8, a merchant specify a matrix 800 of possible awards that depend on the “compensable action” and “compensable customer” parameters. Such a matrix provides finer control in distributing stock-based loyalty awards to customers. For example, a merchant could specify bigger awards for higher margin items or other items that the business would like to focus on (e.g., a new offering). Looking up the applicable amount from the matrix may be done by the merchant, the provider, or a third party. If the merchant performs the look-up, the provider is notified of the amount of the award that is due to a customer. If the provider does the look-up, the merchant provides the provider with information sufficient to perform the look-up (in the example of FIG. 8, the profile of the customer as well as the compensable action taken).

The entries in matrix 800 could be designed to encourage customers to spend more: “3% of your purchase back in Amazon stock for any purchase over $50.” That is, instead of awarding a smaller amount stock for any purchases, no stock could be awarded for purchases below the $50 threshold and a correspondingly larger amount of stock for purchases above the threshold. Distributing awards in this manner is likely to get some customers to purchase another item or two to exceed the threshold.

Matrix 800 also could take into account compensable actions over some period of time. For example, customers could be offered elite status entitling them to a certain percentage stock rebate in any month that they spend at least $50 and a higher percentage in any month they spend at least $100. This would tend to encourage customers to concentrate their purchases at a particular merchant rather than distributing their patronage between the merchant and its competitors.

The system may be implemented to allow flexibility in terms of the awards that are given by a merchant or available to a customer. A privately-held merchant, for example, will not have stock of its own to give out. Such a merchant could be given the opportunity to award shares in a mutual fund or ETF (e.g., S & P 500 SPDRs), some other company's stock (e.g., that of a retailing partner), or even an asset other than stock (e.g., gold, cash, etc.). See, e.g., the 5^{th} and last rows of transaction history 210 in FIG. 2D. Layered or cooperative awards are another example. Using the system of the present disclosure, McDonald's and Coca-Cola could team up to offer some of each company's stock whenever a Coke product is purchased at a McDonald's restaurant. For example, the customer's receipt could include one award identifier for an award of 10 cents of KO stock and 20 cents of MCD stock, or an award identifier that allows the customer to allocate the total award (e.g., 30 cents) over the individual stocks as desired.

Similarly, it may be desirable to give the customer several alternatives in terms of the form of the award. For example, instead of requiring a customer who shops at Merchant A to take that merchant's stock, the provider may allow the customer to choose from one of several alternatives: Merchant A stock, a mutual fund, cash, a conventional merchandise gift card redeemable at Merchant A. In some cases, it may be useful to give the customer a choice of stocks from which to choose. For example, Merchant A may allow its customers to take their rewards in the form of the stock of any of 15 different companies (which may or may not include Merchant A) or cash.

A merchant also could be given the option to “direct deposit” stock into a customer's account, thereby eliminating any need for the recipient to claim the shares. (This option may be advantageous where the customer already has a provider account that the merchant is aware of.)

Further, at some point during the award transaction, value could be added to the award in exchange for the customer's providing other information (e.g., filling out a survey) or taking other action (e.g., purchasing another product or service). For example, when a customer is about to claim a $10 award, or convert it into a merchant's stock, a third party might offer to do a 50% match of award, thereby increasing the total to $15, in exchange for the customer's completing a short survey or purchasing a product from the third party.

The applicability of the present disclosure need not be limited to awards of stock. Other securities, financial instruments, and asset classes could be used in a similar manner In the case of a commodity such as gold, as merchant could give awards redeemable for $1 worth of gold. Bonds and options are other examples. In the case of bonds, a merchant could give an award redeemable for a specified dollar amount of a bond having a specified face value, coupon, and maturity date. In the case of options, a merchant could give an option on an underlying dollar amount (or non-integer number of shares) of stock, or a specified dollar amount's worth of a publicly traded option. As with conventional stock options, a strike price and expiration date for the option may be specified. For such assets, the provider would cover the holdings of its customers in a manner analogous to that described above in connection with FIG. 7.

The system and method of the present disclosure for transferring securities to be claimed by a customer using an award identifier, also could be applied to securities such as stocks, bonds, mutual funds, and options in conventional (non-fractional) amounts. This would avoid the current cumbersome process that is used to transfer the ownership of securities from one entity to another.

It may be desirable to enable the customer to view his account according to the source of the stock he has earned (as opposed to the stocks he currently owns). For example, if a customer earns $10 of stock from Company A and $50 of stock from Company B, but then sells his stock in A for stock in C, the customer still would be able to use a “source view” feature to see that he originally earned $10 of stock from A and $50 of stock from B. Such a feature might appeal to merchants whose stock may not be as popular or appealing to customers, privately-held merchants who awarded a generic asset, like NASDAQ QQQ, or others.

In still another embodiment of the invention, customers could receive awards of a company's stock directly from the company 262, with provider 130 playing a different role than that described above (e.g., an accounting and/or redemption role in which customers could view their holdings for all companies at provider website 131 and/or place redemption orders with provider 130).

In another embodiment, a third party broker could handle the aspects of the invention relating to trading and holding shares. For example, the provider could operate as an introducing broker, with a third party operating as a clearing broker to execute trades, act as custodian, issue statements and confirms, and perform other functions. The provider could operate on a fully-disclosed or omnibus (master/sub account) basis.

In yet another embodiment, there may not be a separate provider. Instead, one entity could play the roles of both company 162 and provider 130. In this case, the entity would offer awards of, maintain database records of, and process claims involving award identifiers good for, its own stock.

Likewise, although the invention has been described in the context of shares that are owned by the provider's customers, it may be desirable (e.g., for regulatory or implementation purposes) for the customers instead to own the cash equivalent of the shares, or a contractual entitlement to the shares or their cash equivalent. For example, a customer may own the cash equivalent of 0.25 shares of Company A's stock, which cash equivalent could fluctuate according to the market value of that stock. For regulatory reasons, it may also be desirable to allow customers to have stock as one of two or more options for the award. The other option or options could be stock in other companies, an ETF, cash, or non-financial rewards.

It may be desirable to some merchants to have certain information about the award not known to the customer (or potentially even the merchant) until the time of claiming. For example, the merchant may wish for the dollar amount, number of shares, or identity of the asset (e.g., that it is Company A or an oil futures contract) to remain a surprise until the time the award identifier is used to claim the award. Similarly, the merchant may wish for the identity of the asset to be generated at the time of claiming. In this case, the system could be implemented to highlight or otherwise emphasize the hidden information when it is finally revealed to the customer. Another alternative is for the customer to determine the amount or type or award at the time of claiming and possibly have this determination depend upon prior awards given, details about the customer, or other conditions.

In the embodiments described in connection with the figures, awards have been described as being given by a merchant to incentivize some action by an individual customer. However, their use is not so restricted. A merchant may give an award to a class of consumers. Or, an employer may give an award that corresponds to an arbitrary dollar amount of stock to a rank-and-file employee as a bonus or as part of a compensation package. A parent might periodically direct awards to a child as an incentive for doing well in school (along the lines of a weekly allowance).

Similarly, a company might offer stock instead of cash to incentivize the recycling of bottles and cans. Anyone turning in a soda can could elect to receive cash (as is done now) or a receipt with an award identifier good for 5 cents of stock in her choice of any of the sponsoring companies. (If the person turned in more bottles and cans, her award identifier might be good for more stock.) The stock may be paid for with the 5 cent deposit that otherwise would be provided in the form of cash, and the corporate sponsor whose stock the customer chose would pay a small fee (e.g., 1 cent) to the provider for handling the associated stock transactions.

Furthermore, it may be desirable to offer provider accounts where stock awards earned by one party are credited to an account held by (or for the benefit of) another party. For example, awards earned by parents and grandparents could be credited to a child's provider account (which may be a custodial account to comply with applicable regulations). The awards may be split among several recipients in desired proportions (e.g., the awards earned by parents would go to their three children equally, or a greater fraction would go to the oldest child, etc.). Where children are involved, in which case the system may provide parental controls to enable parents to monitor their children's activity or authorize certain activities (either on a per-transaction or on a standing basis) before they can be consummated.

It may be desirable to permit companies to provide advertising or other offers that are related in some way to the stocks that a customer owns, has earned recently, or has sold. For example, if a customer earns his first award of Nike stock, an offer for a discount on Nike footwear or a link to Nike's online store could be displayed. Indeed, ads for and offers by other sports and footwear oriented companies—even those of competitors—could be displayed (or blocked by Nike).

The awards, award identifiers, and running totals of the present invention could be implemented with or without expiration dates. For example, an award identifier could be assigned an expiration date (e.g., 90 days from when it was received from the merchant) by the provider or merchant. Should the customer not claim the award by then, the value could revert to the merchant, the provider, or to a third party (e.g., a charity), depending on system implementation.

It may be advantageous to give new customers an opportunity to identify people they know who might want to also earn stock awards. Along these lines, the customer may be provided with a mechanism to upload the contents of an address book (e.g., from Microsoft Outlook®), interface with a social networking website such as Facebook, or manually or otherwise enter information for their contacts. The customer also might be prompted to identify schools (e.g. Roosevelt High School Class of '95), colleges, work places, and other past or current affiliations, enabling the system to identify and display other people sharing one or more of those affiliations for possible identification by the customer.

It may also be advantageous desirable to allow customers to earn stock awards when others earn stock awards, in a multi-tiered way. For example, if a customer refers a friend to sign up for a provider account, the customer may earn an award every time the friend earns an award (e.g., 10% of every award earned by the friend). Through such an implementation, a customer may earn stock in many merchants that her friends patronize, which may lead her to patronize those stores as well, given her new status as a shareholder of those companies. The system could be implemented such that there is a limited time limit period during which for earning additional awards may be earned based on purchases made by the friend (e.g., for the first 6 six months after the friend signs up with the provider). Privacy controls could be made available as well. Without such a controls, the customer would know or might be able to infer where the friend was shopping and how much the friend was spending at each merchant. With such a Privacy controls would mask, the identities of the stocks earned by the friend would be masked, so that the customer would not see where the friend was shopping, and the customer might could be given an opportunity to designate that she receive her additional awards in the form of certain stocks or other assets.

The fractional shares of stock held by provider's customers may be covered by integer shares of stock in ways other than by maintaining a provider inventory as described above. For example, the provider may instead place trades of integer shares of stock periodically (e.g., every Wednesday). In such an implementation, the trade that is placed for a given company's shares may be based on the aggregate face value of stock awards for that company's stock that have been made during the period (e.g., 4 shares of Company A stock may be purchased on a Wednesday if a total of $250 of awards of Coca-Cola stock were made in the preceding 7 day period and Coke was trading at $70/share). In that case, the fixing price for the fractional shares may be the same as the price received by the provider for the integer share trade.

As another example, in an embodiment where the provider operates as an introducing broker separate from a clearing broker that places trades, the provider may employ an “offsetting trades” process to cover its customer's fractional share holdings. In this case, when a stock award is made, a “buy” order for the appropriate fractional amount may be placed with the clearing broker on behalf of the recipient, and an offsetting “sell” order may be placed with the clearing broker on behalf of the provider. The net effect is to transfer a fractional amount of stock from the provider to the recipient, to the extent a direct transfer between provider and customer may be prohibited by regulation or otherwise inappropriate or undesirable.

The present disclosure can be implemented by a general purpose computer programmed in accordance with the principals discussed herein. It may be emphasized that the above-described embodiments, particularly any “preferred” embodiments, are merely possible examples of implementations, merely set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and the present disclosure and protected by the following claims.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a computer readable medium. The computer readable medium can be a machine-readable storage device, a machine-readable storage substrate, a memory device, or a combination of one or more of them.

The term “processor” encompasses all apparatus, devices, and machines for processing data, including by way of example a programmable processor, a computer, or multiple processors or computers. The processor can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more data memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer readable media suitable for storing computer program instructions and data include all forms of storage devices or data memory including non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Those skilled in the art will appreciate that the present invention can be practiced by other than the described embodiments, which are presented for the purposes of illustration and not of limitation, and the present invention is limited only by the claims which follow.

1-17. (canceled)

18. A method of providing promotional rewards of stock, comprising the steps of:
storing promotional reward information in an electronic storage device, wherein the promotional reward information includes an identification of a plurality of merchants, an action that a customer may take and an associated reward redeemable for stock in any of a plurality of publicly traded companies;
providing a graphical user interface to a customer identifying an action that the customer may take at an identified merchant and an associated reward redeemable for stock for a plurality of publicly traded companies and an electronic link for the identified merchant;
electronically receiving a selection from the customer indicating an identified merchant using a provided electronic link;
electronically receiving from the selected merchant, based on the electronic link selected by the customer, the transaction information that is generated based on an action taken by the customer and compensation associated with the stored promotional reward information;
electronically receiving customer information for the customer;
associating a stock brokerage account for the customer based on the received customer information;
using a processor, comparing the received transaction information with the stored promotional reward information to identify a dollar amount of a reward for the customer;
electronically notifying the customer of the availability of a reward redeemable for stock for a plurality of publicly traded companies;
electronically receiving selection information identifying a single company selected from the plurality of publicly traded companies;
using a processor, computing a fractional number of shares associated with the stock in the single company as a function of the identified dollar amount and a price per share for the stock;
purchasing a whole number of shares of the identified stock in the single company on the open market; and
using a processor, transferring the computed fractional number of the shares from the shares purchased on the open market of the identified stock in the single company to the stock brokerage account associated with the customer.

19. The method of claim 18 wherein the promotional reward information is received from a manufacturer of the product.

20. The method of claim 18 wherein the information received for the customer includes a password.

21. The method of claim 18 wherein the information received for the customer is used to open a new stock brokerage account.

22. The method of claim 18 wherein the step of transferring includes transferring the shares of stock from an inventory account.

23. The method of claim 18, wherein a customer purchases plural products and the step of comparing identifies plural rewards for the customer, and the step of transferring includes transferring a number of shares associated with the plural awards.

24. The method of claim 18, wherein the step of transferring occurs when the value of the shares associated with the identified award exceed a predetermined threshold.

25. A method of providing promotional rewards of stock, comprising the steps of:
electronically receiving promotional award information, wherein the promotional reward information includes an identification of a promotional activity to be performed by a customer at a merchant, and a dollar amount that corresponds to a number of shares of stock of a plurality of publicly traded;
providing a graphical user interface to a customer identifying an action that the customer may take at an identified merchant and an associated reward redeemable for stock for a plurality of publicly traded companies and an electronic link for the identified merchant;
electronically receiving a selection from the customer indicating an identified merchant using a provided electronic link;
electronically receiving customer information for a customer who engaged in a promotional activity based on a selected electronic link, and a compensation associated with the promotional activity;
using a processor, comparing the received promotional award information with the received customer information to identify a customer eligible to receive an award of stock;
electronically notifying the customer of the availability of a reward redeemable for stock for a plurality of publicly traded companies;
electronically receiving selection information identifying a single company selected from the plurality of publicly traded companies;
using a processor, computing a fractional number of shares of an award of stock in the single company for the eligible customer as a function of the dollar amount indicated in the received promotional award information and a price per share of the stock;
purchasing a whole number of shares of the identified stock in the single company on the open market;
associating a stock brokerage account for the identified customer based on the received customer information;
using a processor, transferring the identified number of fractional shares from the whole number of shares purchased on the open market associated with the award of stock to the stock brokerage account associated with the eligible customer; and
electronically notifying the eligible customer of the transferring of the shares.

26. The method of claim 25 wherein the step of identifying a fractional number of shares is determined based on the then current market price of the stock and the dollar amount of the associated with the received promotional award information.

27. The method of claim 25 wherein the promotional award program information includes plural dollar amounts, each dollar amount corresponding to a tiered level of an identified promotional activity.

28. The method of claim 27 wherein the tiered level of an identified promotional activity includes purchase levels spent by a customer at a merchant.

29. The method of claim 25 wherein the identified promotional activity does not include the purchase of a product.

30. The method of claim 18 wherein the step of storing includes the customer selecting the single company from the plurality of publicly traded companies.

31. The method of claim 18 wherein the step of purchasing occurs before the step of computing the fractional number of shares associated with the stock in the single company.

32. A computer program product for providing promotional rewards of stock, the computer program product comprising:
a computer usable non-transitory storage medium having computer readable program code modules embodied in said medium for gifting stock, including;
a computer readable first program code module for storing promotional reward information in a storage device, wherein the promotional reward information includes an identification of a product, an action that a customer may take at a merchant and an associated reward redeemable for stock in any of plurality of publicly traded companies;
a computer readable second program code module for providing a graphical user interface to a customer identifying an action that the customer may take at an identified merchant and an associated reward redeemable for stock for a plurality of publicly traded companies and an electronic link for the identified merchant;
a computer readable third program code module for receiving a selection from the customer indicating an identified merchant using a provided electronic link;
a computer readable fourth program module for receiving transaction information from the merchant based on an electronic link selected by the customer, wherein the transaction information includes the identification of an action taken by the customer and compensation associated with the stored promotional reward information;
a computer readable fifth program code module for receiving customer information for the customer;
a computer readable sixth program code module for associating a stock brokerage account for the customer based on the received customer information;
a computer readable seventh program code module for comparing the received transaction information with the stored promotional reward information to identify a dollar amount of a reward for the customer;
a computer readable eighth program code module for notifying the customer of the availability of a reward redeemable for stock for a plurality of publicly traded companies;
a computer readable ninth program code module for receiving selection information identifying a single company selected from the plurality of publicly traded companies;
a computer readable tenth program code module for computing a fractional number of shares of an award of stock in the single company for the eligible customer as a function of the dollar amount indicated in the received promotional award information; and
a computer readable eleventh program code module for transferring the computed fractional number of the shares from whole shares purchased on the open market of the identified stock in the single company to the stock brokerage account associated with the customer.

33. A system for providing promotional rewards of stock, the system comprising:
a memory for storing computer readable code; and
a processor operatively coupled to the memory, the processor configured to:
store promotional reward information in a storage device, wherein the promotional reward information includes an identification of a merchant;
provide a graphical user interface to a customer identifying an action that the customer may take at an identified merchant and an associated reward redeemable for stock for a plurality of publicly traded companies and an electronic link for the identified merchant;
receive a selection from the customer indicating an identified merchant using a provided electronic link;
receive transaction information from the merchant using an electronic link selected by the customer, wherein the transaction information includes the identification of an action taken by the customer and compensation associated with the stored promotion reward;
receive customer information for the customer;
associate a stock brokerage account for the customer based on the received customer information;
compare the received transaction information with the stored promotional reward information to identify a dollar amount of a reward for the customer;
notify the customer of the availability of a reward redeemable for stock for a plurality of publicly traded companies;
receive selection information identifying a single company selected from the plurality of publicly traded companies;
compute a fractional number of shares associated with the stock in the single company as a function of the identified dollar amount and a price per share for the stock; and
transfer the computed fractional number of the shares from whole shares purchased on the open market of the identified stock in the single company to the stock brokerage account associated with the customer.

34. The method of claim 18 wherein the received selection information identifying a single company selected from the plurality of publicly traded companies identifies the merchant.
